(19) United States
(12) Patent Application Publication
(10) Pub. No.: US 2005/0225299 A1
(43) Pub. Date: Oct. 13, 2005

(54) Rapid battery charging method and apparatus

(76) Inventor: Vladimir Petrovic, British Columbia (CA)

Correspondence Address: KLARQUIST SPARKMAN, LLP, 121 SW SALMON STREET, SUITE 1600, PORTLAND, OR, 97204, US

(21) Appl. No.: 10/498,429

(22) PCT Filed: Dec. 10, 2001
(86) PCT No.: PCT/CA01/01733

§ 371 Date: Apr. 22, 2005

(51) Int. Cl. H02J 7/04

(52) U.S. Cl. 320/141

(57) ABSTRACT

Methods and apparatus for battery charging provide a charging cycle in which charging periods are separated by intervals. The intervals may include discharging periods. Typical charging sequences for nickel-metal hydride and nickel-cadmium batteries include charging periods having durations of 9 to 11 seconds during which a battery is charged at a rate between 1.9×C and 2.1×C and intervals which include discharging periods having durations of 0.9 to 1.1 seconds during which the battery is discharged at a rate between 0.19×C and 0.2l×C. The charge-rest-discharge-rest pattern is repeated until a specified battery voltage is reached or another event triggers the end of the charging cycle. Charging methods for lead acid batteries are disclosed in which charging pulses alternate with intervals during which the battery is not being charged. The charging current is stepwise reduced over a number of periods.

### TECHNICAL FIELD

This invention relates to battery charging. In particular the invention relates to methods and apparatus for fast battery charging which provide a charge cycle during which charging pulses are periodically applied to the battery. The invention has particular application in the rapid charging of nickel-metal hydride and nickel-cadmium batteries.

### BACKGROUND

Charging a battery involves passing electrical current through the battery from a suitable direct current electrical power supply. The rate of charge depends upon the magnitude of the charging current. In theory one could reduce charging time by using a higher charging current. In practice, however, there is a limit to the charging current that can be used. All batteries have some internal resistance. Power dissipated as the charging current passes through this internal resistance heats the battery. The heat generated as a battery is charged interferes with the battery's ability to acquire a full charge and, in an extreme case, can damage the battery.

Because the maximum charging rate is limited it can take a long time to charge a battery to its capacity. In some cases, battery charging times as long as 16 hours are standard. The time to charge a particular battery depends upon the capacity and construction of the battery.

Another problem with current battery chargers is that they are not always designed in a way that optimizes the service lives of batteries being charged. Some chargers achieve reduced charging times by providing excessive charging currents in a way which can reduce the life-spans of the batteries under charge. in reliability. Sometimes the deterioration results in a reversible capacity loss or “memory”. With memory, the battery regresses with each recharging to the point where it can hold less than half of its original capacity. This interferes with proper operation of devices powered by the battery. Furthermore, when a battery cannot be fully charged, the battery has a poor ratio of weight to capacity. This is especially significant in electric vehicles.

There is a need for reliable rapid methods for charging batteries. There is a specific need to achieve charging of nickel-metal hydride, nickel-cadmium batteries and lead-acid batteries.

### SUMMARY OF INVENTION

This invention provides methods and apparatus for battery charging. One aspect of the invention provides a method for charging a NiMH or NiCd battery having a capacity C (measured in Ampere-hours). The method comprises applying a series of charging pulses to the battery, the charging pulses each having a duration in the range of 6 seconds to 30 seconds. During each charging pulse a charging current having a magnitude in the range of 0.5×C to 3.0×C is passed through the battery. The battery is not charged during an interval having a duration in the range of 5% of the duration of the previous charging pulse to 20% of the duration of the previous charging pulse.

In some specific embodiments the charging current has a magnitude of:
less than 2.5×C;
in the range of 1.9×C to 2.5×C; or,
in the range of 1.9×C to 2.1×C.

Nickel Cadmium (NiCd) and Nickel Metal Hydride (NiMH) batteries are widely used, especially for powering electronic devices. Such devices often require frequent recharging. In an attempt to produce rapid charging without damaging the batteries various charging schemes have been proposed and used for NiCd and NiMH batteries. Many such schemes require chargers capable of applying high frequency current waveforms to the battery under charge.

Some manufacturers claim outrageously short charge times of 15 minutes, or even less, for nickel-cadmium (NiCd) batteries. With a NiCd battery in perfect condition in a temperature-controlled environment it is sometimes possible to charge the NiCd battery in a very short time by providing a very high charge current. In practical applications, with imperfect battery packs, such rapid charge times are almost impossible to achieve.

Lead-acid batteries a practical type of battery for many heavy-duty applications such as engine-starting, powering electric vehicles, such as forklifts and the like. It is well known that lead-acid batteries should be charged within certain general parameters. It is generally considered that a lead-acid battery should never be charged to its full capacity at a rate greater than 10% to 15% of the battery's capacity. Faster charging increases battery temperature and may damage the battery. Larger charging currents may be applied for short periods when the battery under charge is at a state of low charge to “boost” the battery.

A typical multi-stage charger for lead-acid batteries applies three charge stages. During the first stage, the charger passes a constant charging current through the battery so that it charges to about 70% of its full capacity in about five hours. During the second stage, the charger applies a “topping” charge at a reduced charging current so that the battery charges to its full capacity during a further period of about five hours. In the third stage, the charger applies a float-charge to compensate for self-discharge.

In charging lead-acid batteries, it is also important to observe the cell voltage limit. The limit for the cells of a specific battery is related to the conditions under which the battery is charged. A typical voltage limit range is from 2.30V to 2.45V.

Some battery chargers have been proposed in which the battery under charge is discharged at various points in the charging cycle. This periodic discharging is said to reduce internal resistance and to reduce consequential heating of the battery under charge. An example of such a charger is described in Pittman et al. U.S. Pat. No. 5,998,968. The Pittman et al. charging cycle applies a 2 millisecond discharge immediately before a 100 millisecond charging pulse. The discharge current is greater than the charging current. This pattern repeats at a frequency of about 10 Hertz. Rider et al. U.S. Pat. No. 5,499,234 is another example of this type of battery charger. The Rider et al. charger periodically discharges a battery with a discharge current which is about equal to the charging current. Ayres et al. U.S. Pat. No. 5,561,360 discloses a battery charger which initially applies a constant charging current. When the battery is partially charged, the Ayres et al. charger begins to periodically discharge the battery.

Patents which show other battery chargers are Samsioe, U.S. Pat. No. 4,179,648; Sethi, U.S. Pat. No. 3,622,857; Jones, U.S. Pat. No. 3,857,087; and, Brown Jr. et al., U.S. Pat. No. 5,617,005.

A common difficulty with battery-powered equipment is premature aging of batteries which results in a progressive deterioration

In some specific embodiments the charging pulses each have a duration:
in the range of 9 to 11 seconds; or
in the range of 9½ seconds to 10½ seconds.

In some specific embodiments each interval has a duration:
in the range of 8% to 12% of the duration of the previous charging pulse; or
in the range of 9% to 11% of the duration of the previous charging pulse.

In some embodiments the method comprises during a discharging period in at least a majority of the intervals, allowing the battery to discharge. Allowing the battery to discharge may comprise allowing a discharge current having a magnitude in the range of 0.19×C to 0.21×C to flow. Allowing the battery to discharge may comprise connecting the battery to a resistive load.

In some specific embodiments each discharging period has a duration:
in the range of 0.95 seconds to 1.05 seconds; or,
in the range of 0.9 seconds to 1.1 seconds.

In some specific embodiments the discharge current has a magnitude of about 1/10 of the magnitude of the charging current. In certain embodiments a product of the discharge current and discharge time for each interval does not exceed 2% of a product of the charge current and duration of the immediately previous charging pulse. In certain embodiments, an average over all of the intervals of a product of the discharge current and discharge time for each interval does not exceed 2% of an average over all of the charging pulses of a product of the charge current and duration of the charging pulse.

The method may include terminating charging the battery upon the occurrence of any of various events. Some embodiments of the invention include monitoring a temperature of the battery and suspending charging if the temperature increases at a rate greater than a threshold rate of temperature increase. The threshold rate of temperature increase may be, for example, in the range of 1° C./minute to 3° C./minute. Some embodiments of the invention include terminating the charging upon a maximum charging time having elapsed since commencing the charging. The method may involve monitoring to detect the occurrence of one or more of: an open-circuit voltage of the battery has reached a specified magnitude; a rate of change of the open circuit voltage becomes negative; a predetermined time has elapsed since the start of the charge cycle; and, a temperature of the battery under charge increases at a rate which is greater than a specified threshold. The method may terminate charging the battery upon detecting any of these occurrences. Methods according to some embodiments of the invention include monitoring to detect the occurrence of each of: a predetermined time has elapsed since the start of the charge cycle; and, a temperature of the battery under charge increases at a rate which is greater than a specified threshold; and terminating charging the battery upon detecting the occurrence of either a predetermined time has elapsed since the start of the charge cycle; or a temperature of the battery under charge increases at a rate which is greater than a specified threshold.

Another aspect of the invention provides a battery charger. The battery charger may be used to charge a NiCd or NiMH battery having a capacity C Ampere-hours. The battery charger according to this aspect of the invention comprises a power supply; and, a control circuit configured to cause the power supply to apply a series of charging pulses to the battery, the charging pulses each having a duration in the range of 6 seconds to 30 seconds and delivering a charging current having a magnitude in the range of 0.5×C to 3.0×C. The control circuit is also configured to control the power supply or circuitry associated with the power supply so that it does not pass charging current through the battery during an interval having a duration in the range of 5% of the duration of the previous charging pulse to 20% of the duration of the previous charging pulse.

In some embodiments the battery charger comprises a load and a switch controlled by the control circuit and the control circuit is configured to operate the switch to connect the battery to discharge through the load during at least a majority of the intervals. The control circuit may comprise a programmable device.

A further aspect of the invention provides a method for charging a lead-acid battery. The method includes setting an initial magnitude of a charging current to a value in the range of 0.65×C to 0.70×C; for a charging period having a duration in the range of 60 to 180 seconds, passing the charging current through the battery; for a discharging period having a duration in the range of 10 to 20 seconds, allowing the battery to discharge at a current having a magnitude in the range of 0.05×C to 0.07×C; repeating the constant current charging and discharging steps in alternating sequence during a period having a length in the range of 15 minutes to 26 minutes; decreasing the magnitude of the charging current by approximately 0.05×C; repeating sets of the constant current charging and discharging steps in alternating sequence followed by the decrease in charging current variable step, each set lasting for a duration of time of 15 minutes to 26 minutes, until the value of the charging current variable is less than or equal to 0.5×C; setting the value of the charging current variable to 0.5×C; repeating the constant current charging and discharging steps in alternating sequence until the battery voltage reaches a specified magnitude; setting the value of a charging voltage variable to a specified magnitude; for a charging period having a duration in the range of 60 seconds to 180 seconds, applying a charging voltage having a magnitude equal to the value of the charging voltage variable to the battery; for a discharging period having a duration in the range of 10 seconds to 20 seconds allowing the battery to discharge a current having a magnitude in the range of 0.05×C to 0.07×C through a load; and repeating the constant voltage charging and discharging steps in alternating sequence until the charging current reaches a specified magnitude or the time spent repeating the charging and discharging steps above reaches a specified duration.

In preferred embodiments the duration of the charging period for a lead-acid battery is in the range of 100 seconds to 140 seconds.

The invention also provides battery chargers which perform methods according to the invention.

Some embodiments have a shut-off timer configured to discontinue the charging cycle after a period in the range of 100 minutes to 180 minutes if the battery is a lead-acid battery; and configured to discontinue the charging cycle after a period in the range of 20 minutes to 60 minutes if the battery is a nickel-metal hydride or nickel-cadmium battery. Most preferably the shut off timer ends the charging cycle for lead acid batteries in about 2 hours.

Some embodiments have a voltage comparator connected to compare a voltage of a battery under test to a reference voltage. In these embodiments the control circuit is configured to, before initiating the charging cycle, determine if the voltage comparator indicates that the battery voltage is greater than the reference voltage. If so, the control circuit connects the load between the terminals of the battery under charge until the battery voltage is equal to or less than the reference voltage. This ensures that batteries being charged are all started at about the same level of charge.

Some embodiments use a temperature sensor, such as a thermistor, to measure the temperature of a battery under charge so that the rate of temperature rise may be monitored. Charging can be suspended or the charging power applied to the battery under charge can be reduced when the rate of temperature rise exceeds a threshold. The threshold may be 2 degrees Celsius per minute.

Further features and advantages of the invention are described below.

### BRIEF DESCRIPTION OF THE DRAWINGS

In drawings which illustrate non-limiting embodiments of the invention:

FIG. 1 is a flowchart showing a method of charging a nickel-metal hydride or nickel-cadmium battery;

FIG. 2 is a plot of current and voltage supplied to and obtained from a nickel-metal hydride or nickel-cadmium battery as a function of time for a preferred embodiment of the invention;

FIG. 3 is a flowchart showing a method of charging a lead-acid battery;

FIG. 4 is a plot of current and voltage supplied to and obtained from a lead-acid battery as a function of time for a preferred embodiment of the invention;

FIG. 5 is a block diagram of a battery charger according to a simple embodiment of the invention; and,

FIG. 6 is an electrical schematic for a fast charger according to a specific embodiment of the invention.

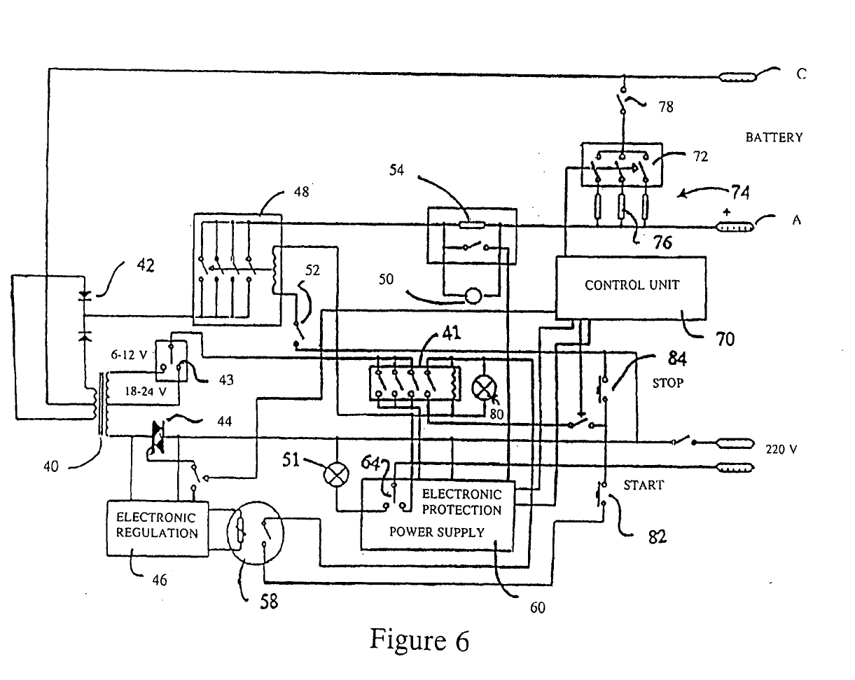

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention has particular application to charging nickel-metal hydride (NiMH), and nickel-cadmium (NiCd) batteries. Methods and apparatus for charging lead-acid batteries are also disclosed. A battery charger according to the invention may have programs to accommodate multiple battery types.

Charging NiMH or NiCd Batteries

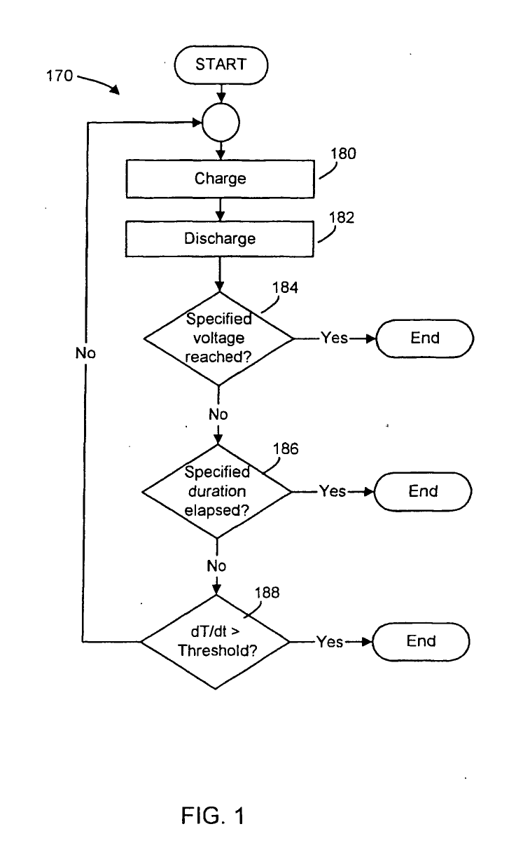

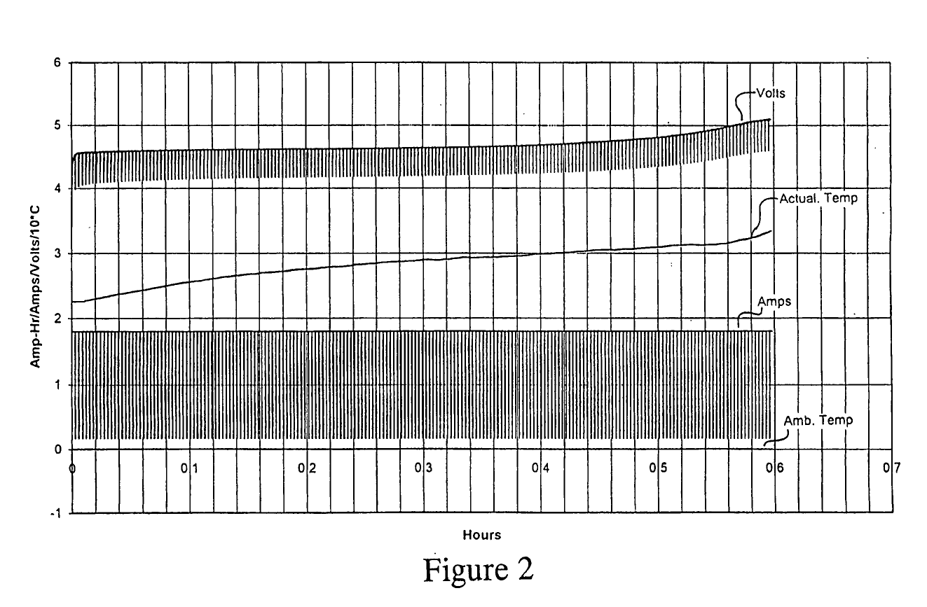

FIG. 1 is a flowchart showing a method 170 for charging a NiMH or NiCd battery according to this invention. FIG. 2 is a plot of current and voltage at the terminals of a NiMH or NiCd battery as a function of time during a charge cycle according to a preferred embodiment of the invention. At step 180, a charging pulse is applied to the battery under charge. During the charging pulse, the battery under charge is charged at a charging current. The charging current is in the range of about 0.5×C to 3×C, where C is the capacity of the battery in Ampere-Hours.

Except as otherwise noted in this application, electrical currents are expressed in Amperes (A) and battery capacity is expressed in Ampere-hours (Ah). A current may be specified in relation to a battery's capacity. For example, for a 6 Ampere-hour capacity battery (i.e. C=6), a charging current of 2×C is 2×6=12 Amperes. For a 15 Ampere-hour battery (i.e. C=15), a charging current of 1.1×C is 1.1×15=16.5 Amperes.

In preferred embodiments the charge current is in the range of 1.9×C to 2.5×C. For low capacity batteries, such as batteries suitable for use in cellular telephones or other portable electronic devices, a charge current of approximately 2.2×C may be used. Such batteries typically have capacities of less than about 20 Ampere-hours. For larger batteries a somewhat lower charging current, for example about 2.0×C is preferable. Such batteries typically have capacities exceeding 5 Ampere-hours. Larger batteries typically require a lower charging rate (in multiples of C) than smaller batteries because larger batteries tend to have a smaller ratio of surface area to volume than smaller batteries. Consequently, heating can be more significant in larger batteries. The shape and dimensions of individual batteries have significant effects on the rate at which heat generated during charging can be dissipated.

The charging current is applied for a charge time. The charge time may be in the range of 6 seconds to 30 seconds and is preferably in the range of 9 to 11 seconds (most preferably the charge time is in the range of 9½ seconds to 10½ seconds).

The charging pulses are separated by intervals which have a duration of about 20% or less of the charge time, the intervals may have a duration in the range of 5% of the charge time to 20% of the charge time. The intervals are preferably in the range of 8% of the charge time to 12% of the charge time, and most preferably the intervals have a duration of 9% to 11% of the charge time.

Preferably, during the intervals, the battery is discharged. In the illustrated method, at step 182, the battery under charge is discharged at a discharge current. The discharge current is preferably less than 20% of the charging current. The discharge current is preferably greater than 5% of the charging current. The discharge current is preferably about 1/10 of the charging current. In typical cases the magnitude of the discharge current may be in the range of 0.19×C to 0.21×C.

The discharge current may be drawn during a discharge time in the range of 0.9 seconds to 1.1 seconds (the discharge time is preferably in the range of 0.95 seconds to 1.05 seconds).

The discharge time may equal, or nearly equal the duration of the intervals. The product of the discharge current and discharge time during each interval (i.e. the area Al under a graph of current vs time for the interval) may be in the range of 0.5% to 2% of the product of the charging current and charging time during the previous charging pulse (i.e. the area A2 under the graph of current vs. time for the charging pulse).

Preferably the intervals include short rest periods (not shown in FIG. 2) before and after each charge time. The rest periods are preferably no longer than about 2% of the duration of the charging period and may be very short, for example about ⅕ second or less.

Steps 180 and 182 are repeated until the battery has a desired charge. Steps 180 to 186 repeat the charge-rest-discharge-rest pattern until it is determined that the battery is fully charged. A determination of full charge may be made by any or all of:
monitoring the open-circuit battery voltage and determining when the open circuit battery voltage has reached a specified magnitude as determined in step 184;
monitoring open circuit voltage and terminating charging when a rate of charge of open circuit voltage becomes negative;
monitoring the length of the charging cycle and terminating charging when a predetermined time has elapsed since the start of the charge cycle, as determined in step 186; or,
monitoring temperature of the battery under charge and terminating charging when the temperature increases at a rate which is greater than a specified threshold (the threshold may be, for example a rate of temperature increase in the range of 1° C./minute to 3° C./minute ), as determined in step 188.
   Preferably charging is terminated whenever any one of two or more of the foregoing conditions occurs.

After the battery under charge is fully charged, a floating charge cycle, as known in the prior art, may be applied to the battery under charge to compensate for self-discharge.

Charging Lead-Acid Batteries

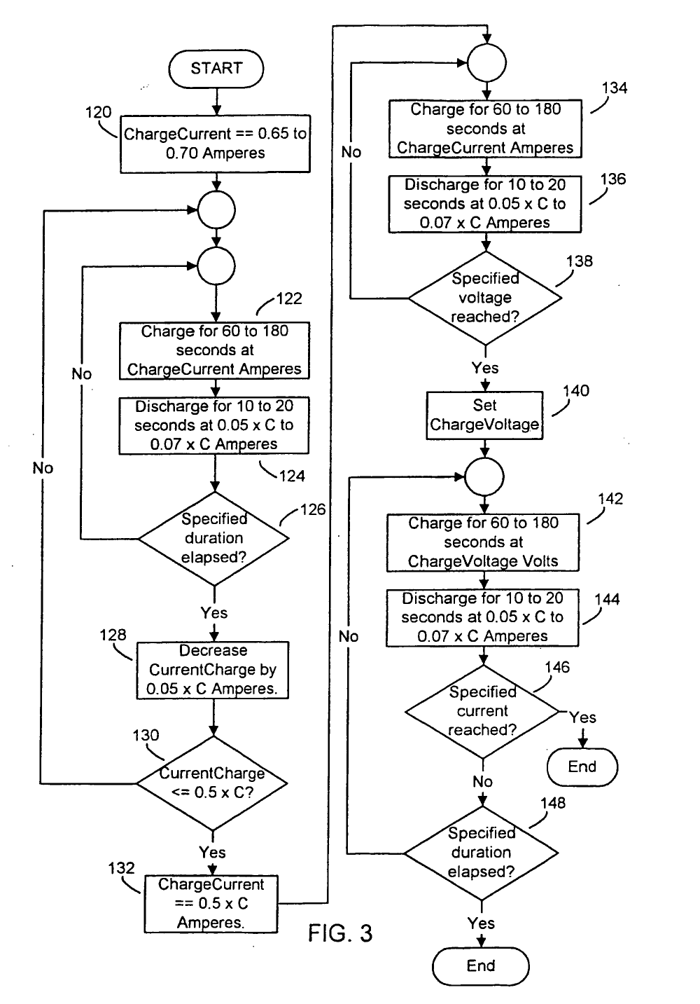

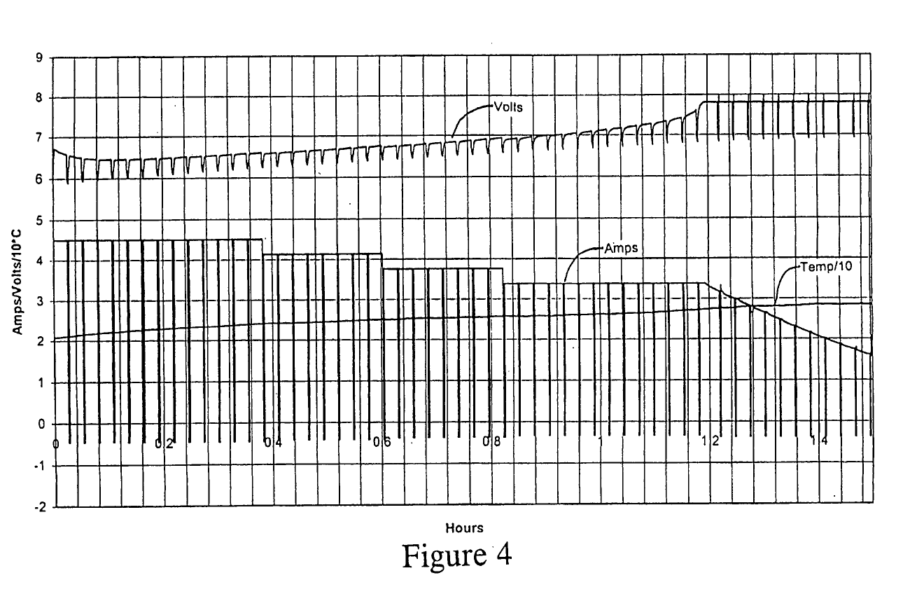

FIG. 3 is a flowchart showing a method of charging a lead-acid battery according to this invention. FIG. 4 is a plot of current and voltage supplied to and obtained from a lead-acid battery as a function of time during the method of FIG. 3. Referring to FIG. 3, step 120 sets the charging current to an initial rate in the range of 0.65×C to 0.70×C.

At step 122 the battery under charge is charged at the charging current provided in step 120 for a time in the range of 60 seconds to 180 seconds (preferably in the range of 100 seconds to 140 seconds). The charging pulses of step 122 are repeated.

Adjacent charging pulses are separated from one another by intervals. The intervals have durations in the range of 10 seconds to 20 seconds (preferably in the range of 13 seconds to 17 seconds).

In preferred embodiments, the intervals include periods during which the battery is discharged (step 124). The rate of discharge may be as much as about 0.07×C. The rate of discharge may be in the range of about 0.05×C to 0.07×C. Steps 122 and 124 are repeated.

Preferably there are short rest periods before and after each charging period (not shown in FIG. 4). The rest periods are preferably no longer than about 2% of the duration of the charging period and may be very short, for example about ⅕ second (about 200 milliseconds) or less.

The charge-rest-discharge-rest pattern is repeated, initially with the charge portion at a charging current of 0.65×C to 0.70×C, until the end of a first period, as determined in step 126. In the preferred embodiment, the first period has a length in the range of 15 to 20 minutes, which is about one-eighth of the total charge time for a lead-acid battery in the preferred embodiment of the invention. At the end of the first period the charging current is decreased stepwise by about 0.05×C (step 128).

The charging cycle of steps 122 through 128 is repeated for successive periods. At the end of each period the charging current is stepwise reduced by about 0.05×C. In the preferred embodiment the stepwise reduction in charging current is in approximately the same amount (i.e. the amounts are within about 10% of each other) at the end of each period. Each period has a length in the range of 15 to 20 minutes, which is preferably the same as the length of the first period.

The periods are not necessarily equal in length, although they may be. If the periods are not equal in length then preferably the first period, which corresponds to a time during which the battery under charge has a higher acceptance, is longer than subsequent periods. The periods are preferably about 22 minutes long on average so that four periods occupy roughly 90 minutes.

This pattern continues until the step down in charging current at the end of a period would reduce the charging current to less than 0.5×C. This would typically occur at the end of the fourth period which ends at some time between 60 to 100 minutes (and preferably about 90 minutes) after the start of the charge cycle. During the fourth period the charging current is typically in the range of about 0.5×C to 0.55×C. At the end of the period in which the charging current would be reduced to a value of less than 0.5 C, as determined by step 130, the charging current is set in step 132 to a fixed value of about 0.5×C±5%.

In steps 134 and 136, the charge-rest-discharge-rest pattern is repeated, with charging occurring at the fixed value until the battery voltage reaches a specified magnitude as determined in step 138. When the battery voltage has reached the specified voltage, the constant current mode of steps 120 to 138 ends and a constant voltage mode begins at step 140. Step 140 sets a charging voltage to a specified magnitude. Steps 142 to 148 repeats the charge-rest-discharge-rest pattern with the charging current delivered at the voltage set in step 140 until the charging current has decreased to a specified magnitude as determined in step 146 or until the charging has been ongoing for a specified duration as determined in step 148, whichever occurs first. The main charging cycle then terminates. After the main charging cycle has terminated a float-charge may be applied periodically to compensate for self-discharge.

Apparatus

FIG. 4 is a block diagram of a battery charger according to a simple embodiment of the invention. A battery charger 10 has a power supply 12 which supplies a charging current suitable for a given battery under charge.

Power supply 12 may have both constant current and constant voltage modes. This is desirable for charging lead-acid batteries. In embodiments for charging NiCd or NiMH batteries, power supply 12 may comprise a constant current power supply. Where the charging cycle includes discharging periods, charger 10 includes a load 14. Load 14 is preferably a resistive load. For example, load 14 may comprise a high wattage resistor, or a number of high wattage resistors in parallel. Load 14 presents a resistance such that a desired discharge current, as described above, flows through load 14 when load 14 is connected between the terminals A and C of a battery B which is under charge.

A switch 16 controlled by a control circuit 18 can connect terminals A and C of battery B either to power supply 12 or to load 14. Control circuit 18 generates a signal SI which causes switch 16 to alternate between a configuration in which power supply 12 is connected between terminals A and C for a charging time having a specified duration and a configuration wherein load 14 is connected across terminals A and C during a discharging time having a specified duration. During the charging time, control circuit controls power supply 12 by way of a signal S2 to be in the appropriate mode (constant current or constant voltage) and, to supply charging current to battery B at the appropriate charging current or voltage, as discussed above.

Preferably charger 10 includes a voltage monitoring circuit 20 which senses the voltage of battery B a temperature monitoring circuit 21 which senses a temperature of battery B and a timer 22. Controller 18 terminates the charging cycle when a signal from one or more of circuit 20, circuit 21 or timer 22 indicates that battery B is fully charged. Where the charger is charging a lead-acid battery controller 18 may use the input from circuit 20 to determine when to initiate the constant voltage mode of step 140.

Controller 18 may comprise a circuit made up of discrete components, an application specific integrated circuit, a programmed microcontroller, or the like. Where controller 18 comprises a programmable device, the operation of charger 10 can be altered by providing a different program for execution by controller 18.

The invention may be practiced with the use of a conventional battery charger which has been modified by the installation of an electronic control module, a switch and a load.

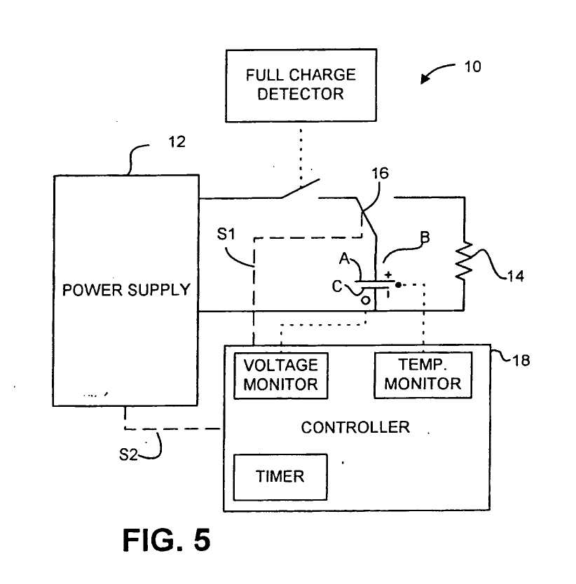

FIG. 5 shows an electrical schematic for a fast charger 22 according to a specific embodiment of the invention which uses primarily discrete components. Fast charger 22 has a power supply section which comprises a power transformer 40, and a pair of rectifiers 42 which convert the alternating voltage output from transformer 40 to direct current. Mains power is supplied to transformer 40 by way of a primary contactor 41.

Contactor 41 typically comprises a relay. However, contactor 41 may comprise any electrically controllable device capable of switching on or off the electrical power to transformer 40. A voltage output of the power supply can be selected by means of a voltage select switch 43.

Power to transformer 40 is controlled by a triac 44 which is triggered by an electronic regulation circuit 46. Triac 44 selectively permits rectified direct current to be applied to a battery under charge.

A contactor 48 is provided to disconnect charging current from the battery under charge in case charger 22 overheats or needs to be shut down for some other reason. Contactor 48 may comprise a relay or any other electrically controllable device capable of switching on or off the charging current supplied to the battery under charge. When contactor 48 is closed and triac 44 is energized, electrical current can flow in a circuit which extends from rectifiers 42 through contactor 48, through the battery under charge and back to power transformer 40.

An ammeter 50 may be provided to indicate the magnitude of the electrical current flowing through battery B during the charging periods. A polarity indicating lamp 51 lights when the leads of the charger have been connected to the correct terminals of battery B (or in the alternative to warn a user that battery B has been connected the wrong way).

Preferably charger 22 has a thermal cutout 52 which causes contactor 48 to open whenever charger 22 becomes overheated and a short circuit cut out 54, which may be a thermomagnetic protector, which prevents damage to charger 22 by disconnecting the charger in the event of a short circuit between the leads which are connected to the battery under charge. Thermal cutout 52 is preferably of a type such that it is automatically reconnected a short time after the temperature of the charger returns to normal. For example, when thermal cutout 52 shuts charger 22 off it may automatically reconnect the charger after approximately 10 minutes.

The charging current delivered by charger 22 is regulated by circuit 46. A potentiometer 58 allows control circuit 70 to set the appropriate charging current for the battery under charge. Where charger 22 is for lead-acid batteries, potentiometer 58 is preferably a device controlled by controller 70 so that controller 70 can set charging currents for the different charging stages of the charge cycle.

An electronic protection circuit 60 prevents charger 22 from operating if no battery is connected to the charger or if a battery is connected with reverse polarity. If a battery is connected with reverse polarity then protection circuit 60 switches switch 64 so that lamp 51 is lit and no power is available to cause contactor 48 to close. If a battery is correctly connected to charger 22 then protection circuit 60 switches switch 64 under the control of control circuit 70 so as to supply power to cause contactor 48 to close.

Charger 22 has a discharge contactor 72 which, when closed, connects a load 74, which may comprise resistors 76 across the terminals of the battery under charge. Contactor 72 may comprise a relay or any other electrically controllable device capable of connecting load 74 between the terminals of a battery under charge. Charger 22 has a switch 78 which can be manually opened to disable the discharging function of charger 22. A pilot light 80 indicates when primary contactor 41 of charger 22 is closed. Start and stop switches 82 and 84 permit the charging cycle to be initiated or discontinued.

Most components of charger 22, except control circuit 70, load 74, switch 78 and discharge contactor 72, can be found in conventional battery chargers and their operation is well understood to those skilled in the art.

Control circuit 70 of charger 22 preferably includes a timer that switches charger 22 off after a suitable interval.

Control circuit 70 may be implemented in any of a wide variety of ways. For example, control circuit 70 may comprise a suitably programmed microcontroller, a number of interconnected timing circuits or the like. Those skilled in the art will understand that any of a wide variety of well known timing circuits and techniques may be used to operate the charging and discharging relays in alternating sequence as described herein and to periodically adjust the charge current and voltage as described above.

The use of this invention provides significant benefits in charging NiMH and NiCd batteries. Total charge time for NiMH/NiCd batteries may be approximately ½ hour. Total charge time for lead acid batteries may be approximately two hours. This is significantly faster than is possible with conventional battery chargers which charge at constant currents which are typically less than 0.15×C.

The cycle of repeatedly charging and discharging a battery for the time periods set out above can help to reduce the “memory” effect which can reduce the capacity of a battery over time. The maximum charge that can be imparted to a battery is increased when the methods of the invention are used as a result of decreased heating.

It can be appreciated that existing battery chargers can be modified to provide the charging cycle of this invention. Charging current does not need to be switched on and off at high frequency as is required by some previous charging technologies.

As will be apparent to those skilled in the art in the light of the foregoing disclosure, many alterations and modifications are possible in the practice of this invention without departing from the spirit or scope thereof. For example:
providing discharge times may be less significant when the battery under charge is at a state of low charge. The invention could be practiced by charging a battery at a substantially constant current for an initial period and then commencing the alternating cycle of charging periods and discharging periods as described herein.
The lengths of the charge times, discharge times and intervals do not need to be constant throughout the charging cycle. These times may vary within the permitted ranges.

Accordingly, the scope of the invention is to be construed in accordance with the substance defined by the following claims.

1. A method for charging a NiMH or NiCd battery having a capacity C, the method comprising:
applying a series of charging pulses to the battery, the charging pulses each having a duration in the range of 6 seconds to 30 seconds;
during each charging pulse passing a charging current having a magnitude in the range of 0.5×C to 3.0×C through the battery;
not charging the battery during an interval having a duration in the range of 5% of the duration of the previous charging pulse to 20% of the duration of the previous charging pulse.

2. The method of claim 1 wherein the charging current has a magnitude less than 2.5×C.

3. The method of claim 1 wherein the charging current is in the range of 1.9×C to 2.5×C.

4. The method of claim 1 wherein the charging current is in the range of 1.9×C to 2.1×C.

5. The method of claim 1 wherein the battery has a capacity of less than 20 Ampere-hours and the charging current is approximately 2.2×C.

6. The method of claim 1 wherein the battery has a capacity in excess of 5 Ampere-hours and the charging current is approximately 2.0×C.

7. The method of claim 1 wherein the charging pulses each have a duration in the range of 9 to 11 seconds.

8. The method of claim 7 wherein the charging pulses each have a duration in the range of 9½ seconds to 10½ seconds.

9. The method of claim 1 wherein each interval has a duration in the range of 8% of the duration of the previous charging pulse to 12% of the duration of the previous charging pulse.

10. The method of claim 9 wherein each interval has a duration in the range of 9% of the duration of the previous charging pulse to 11% of the duration of the previous charging pulse.

11. The method of claim 1 comprising, during a discharging period in at least a majority of the intervals, allowing the battery to discharge.

12. The method of claim 11 wherein allowing the battery to discharge comprises allowing a discharge current having a magnitude in the range of 0.19×C to 0.21×C to flow.

13. The method of claim 11 wherein allowing the battery to discharge comprises connecting the battery to a resistive load.

14. The method of claim 12 wherein the discharging period in has a duration in the range of 0.95 seconds to 1.05 seconds.

15. The method of claim 12 wherein the discharging period in has a duration in the range of 0.9 seconds to 1.1 seconds.

16. The method of claim 12 wherein the discharge current has a magnitude of about 1/10 of the magnitude of the charging current.

17. The method of claim 11 wherein a product of the discharge current and discharge time for each interval does not exceed 2% of a product of the charge current and duration of the immediately previous charging pulse.

18. The method of claim 17 wherein for at least a majority of the intervals, the product of the discharge current and discharge time exceeds ½% of a product of the charge current and duration of the immediately previous charging pulse.

19. The method of claim 11 wherein an average over all of the intervals of a product of the discharge current and discharge time for each interval does not exceed 2% of an average over all of the charging pulses of a product of the charge current and duration of the charging pulse.

20. The method of claim 11 comprising, between each charging period and the preceding discharging period, waiting for a first rest period having a duration of no more than 2% of the duration of the charging period wherein, during the first rest period, no current is flowing through the battery.

21. The method of claim 20 comprising, between each charging period and the following discharging period, waiting for a second rest period having a duration of no more than 2% of the duration of the charging period wherein, during the second rest period, no current is flowing through the battery.

22. The method of claim 1 comprising, monitoring a temperature of the battery and suspending charging if the temperature increases at a rate greater than a threshold rate of temperature increase.

23. The method of claim 22 wherein the threshold rate of temperature increase is in the range of 1° C./minute to 3° C./minute.

24. The method of claim 1 comprising terminating the charging upon a maximum charging time having elapsed since commencing the charging.

25. The method of claim 1 comprising monitoring to detect the occurrence of one or more of:
an open-circuit voltage of the battery has reached a specified magnitude;
a rate of change of the open circuit voltage becomes negative;
a predetermined time has elapsed since the start of the charge cycle; and,
a temperature of the battery under charge increases at a rate which is greater than a specified threshold and terminating charging the battery upon detecting the occurrence.

26. The method of claim 1 comprising monitoring to detect the occurrence of each of:
a predetermined time has elapsed since the start of the charge cycle; and,
a temperature of the battery under charge increases at a rate which is greater than a specified threshold and terminating charging the battery upon detecting the occurrence of either a predetermined time has elapsed since the start of the charge cycle; or a temperature of the battery under charge increases at a rate which is greater than a specified threshold.

27. A battery charger for charging a NiCd or NiMH battery having a capacity of C Ampere-hours, the battery charger comprising:
a) a power supply; and,
b) a control circuit configured to:
cause the power supply to apply a series of charging pulses to the battery, the charging pulses each having a duration in the range of 6 seconds to 30 seconds and delivering a charging current having a magnitude in the range of 0.5×C to 3.0×C; and, not pass charging current through the battery during an interval having a duration in the range of 5% of the duration of the previous charging pulse to 20% of the duration of the previous charging pulse.

28. The battery charger of claim 27 comprising a load and a switch controlled by the control circuit wherein the control circuit is configured to operate,the switch to connect the battery to discharge through the load during at least a majority of the intervals.

29. The battery charger of claim 28 wherein the switch comprises an electrically controllable switching circuit having a first state in which the power supply is connected between positive and negative terminals of a battery under charge and a second state wherein the load is connected between the positive and negative terminals of the battery under charge.

30. The battery charger of claim 27 wherein the control circuit comprises a programmable device.

31. The battery charger of claim 27 comprising a shut-off timer connected to measure a time elapsed since a start of a charging cycle, wherein the control circuit is configured to discontinue the charging cycle after the shut of timer indicates that the time elapsed since the start of the charging cycle exceeds a threshold.

32. The battery charger of claim 28 comprising a voltage comparator connected to compare a voltage of a battery under charge to a reference voltage wherein the control circuit is configured to, before initiating the charging cycle, determine if the voltage comparator indicates that the battery voltage is greater than the reference voltage and, if so, connect the load between the terminals of the battery under charge until the battery voltage is equal to or less than the reference voltage.

33. A method for charging a lead-acid battery, the method comprising:
a) setting a charging current magnitude to an initial value in the range of 0.65×C to 0.70×C;
b) for a charging time having a duration in the range of 60 seconds to 180 seconds, passing a charging current at the charging current magnitude through the battery;
c) for a discharge time having a duration in the range of 10 seconds to 20 seconds allowing the battery to discharge at a rate in the range of 0.05×C to 0.07×C;
d) repeating steps (b) and (c) in alternating sequence for a period having a duration in the range of 15 minutes to 26 minutes;
e) at the end of the period decreasing the charging current magnitude by approximately 0.05×C;
f) repeating steps (b) through (d) until the charging current magnitude is less than or equal to 0.5×C;
g) setting the charging current magnitude to approximately 0.5×C;
h) for a charging time having a duration in the range of 60 seconds to 180 seconds, passing a charging current at the charging current magnitude through the battery;
i) for a discharge time having a duration in the range of 10 seconds to 20 seconds allowing the battery to discharge at a current having a magnitude in the range of 0.05×C to 0.07×C;
j) repeating steps (h) and (i) in alternating sequence until the battery voltage reaches a threshold value;
k) setting a charging voltage to a specified value;
l) for a charging period having a duration in the range of 60 seconds to 180 seconds, applying the charging voltage to the battery;
m) for a discharging period having a duration in the range of 10 seconds to 20 seconds allowing the battery to at a current having a magnitude in the range of 0.05×C to 0.07×C; and,
n) repeating steps (l) and (m) in alternating sequence until the battery is substantially fully charged.

34. The method of claim 33 wherein the duration of the discharging period in step (c) is in the range of 13 to 17 seconds.

35. The method of claim 34 wherein the battery has a nominal output voltage, V, and the threshold voltage is in the range of 2.5×V to 2.6×V per cell.

36. The method of claim 33 comprising, between each charging period and the preceding discharging period, waiting for a first rest period having a duration of no more than 2% of the duration of the charging period wherein, during the first rest period, no current is flowing through the battery.

37. The method of claim 36 comprising, between each charging period and the following discharging period, waiting for a second rest period having a duration of no more than 2% of the duration of the charging period wherein, during the second rest period, no current is flowing through the battery.

38. The method of claim 37 wherein the second rest period has a duration of less than 200 milliseconds.

39. The method of claim 33 comprising, before step (ii), monitoring a voltage of the battery and, if the voltage is greater than a threshold value, discharging the battery until the battery voltage is equal to or less than the threshold value.

40. The method of claim 39 wherein discharging the battery is performed at a rate in the range of 0.05×C to 0.07×C.

41. A method for charging a lead-acid battery, having a capacity C the method comprising:
a) during each of a plurality of periods each having a duration in the range of 15 minutes to 25 minutes alternating between passing a charging current through the battery, the charging current being stepwise reduced in each successive period and providing an interval during which the battery is not being charged;
b) when the charging current has been stepwise reduced to a threshold value, maintaining the charging current at the threshold value and continuing to alternate between passing the charging current through the battery and providing the intervals until a voltage of the battery reaches a threshold voltage;
c) upon the battery voltage reaching the threshold voltage, maintaining a charging voltage at a constant value and continuing to between passing the charging current through the battery and providing the intervals; and,
d) terminating charging when the charging current produced by the charging voltage is less than a threshold current.

42. The method of claim 41 comprising, during at least a majority of the intervals, allowing the battery to discharge through a load at a rate of approximately 10% of an initial charging current.
